(19) United States
(12) Patent Application Publication
(10) Pub. No.: US 2025/0364794 A1
(43) Pub. Date: Nov. 27, 2025

(54) CABLE HANGER WITH STABILIZNG MEMBERS

(71) Applicant: OUTDOOR WIRELESS NETWORKS LLC, Claremont, NC (US)

(72) Inventor: Ronald A. Vaccaro, Taylorsville, NC (US)

(21) Appl. No.: 18/873,456

(22) PCT Filed: Jul. 5, 2023
(86) PCT No.: PCT/US2023/069609

§ 371 Date: Dec. 10, 2024

Related U.S. Application Data
(60) Provisional application No. 63/390,315, filed on Jul. 19, 2022.

(51) Int. Cl. H02G 3/32

(52) U.S. Cl. CPC H02G 3/32

(57) ABSTRACT

A cable hanger includes: a generally flat base with at least one opening: first and second arms extending in a first direction from opposite edges of the base: first and second locking members extending in the first direction from, respectively. ends of the first and second arms. each of the locking members comprising a respective hook: first and second gripping members, each of the first and second gripping members extending from the base or one of the arms and forming a pocket configured to receive and grasp a cable: and a fixed-fixed beam support member extending from the base and/or the first arm. the support member sized and positioned to engage the first gripping member when the first gripping member deflects to grasp a cable. The first and second locking members are forced toward each other to mount the cable hanger in a mounting location via the hooks, such movement causing the first and second gripping members to grasp a cable in the pocket.

### RELATED APPLICATION

The present application claims priority from and the benefit of U.S. Provisional Patent Application No. 63/390,315, filed Jul. 19, 2022, the disclosure of which is hereby incorporated herein by reference in full.

### FIELD OF THE INVENTION

The present invention relates generally to devices for supporting cables and, in particular, to hangers for securing cables to support structures.

### BACKGROUND OF THE INVENTION

Cable hangers are commonly used to secure cables to structural members of antenna towers and/or along tunnel walls. Generally, each cable is attached to a structural member by cable hangers mounted at periodically-spaced attachment points.

Antenna towers and or tunnels may be crowded due to the large numbers of cables required for signal-carrying. Over time, as systems are added, upgraded and/or expanded, installation of additional cables may be required. To conserve space, it may be desirable for each set of cable hangers to secure more than a single cable. Certain cable hangers have been constructed to secure multiple cables; other cable hangers have a stackable construction that permits multiple cable hangers to be interlocked extending outwardly from each mounting point/structural member. Stacked and multiple-cable hangers significantly increase the number of cables mountable to a single attachment point.

One popular stackable cable hanger is discussed in U.S. Pat. No. 8,191,836 to Korczak, the disclosure of which is hereby incorporated herein in its entirety. Hangers disclosed therein have generally a U-or C-shaped profile with rounded arms. A locking projection extends from the free end of each arm, and the “root” of the hanger that spans the fixed ends of the arms has a large aperture. The hanger can hold a cable between the arms; gripping of the cable is enhanced by short fingers that extend inwardly from the arms to engage the cable. Hangers can be “stacked” onto each other by inserting the locking projections of one hanger into the large aperture of the next hanger.

One variety of cable hanger of this type is the SNAP-STAK® hanger, available from CommScope, Inc. (Joliet, Illinois). The SNAP-STAK® hanger is offered in multiple sizes that correspond to the outer diameters of different cables. This arrangement has been suitable for use with coaxial power cables, which tend to be manufactured in only a few different outer diameters. Modified versions of these hangers are discussed in U.S. Pat. No. 9,866,004 to Vaccaro, hereby incorporated herein by reference in full; these arrangements may be more desirable for fiber optic and hybrid cables, which tend to be manufactured in a much greater variety of diameters, and which tend to be much heavier than coaxial cables (sometimes as much as three times heavier per unit foot), which induces greater load and stress on the hangers. Additional hanger configurations are discussed in U.S. Pat. Nos. 10,253,906; 10,823,312; 10,422,446; and 10,634,265, all of which are hereby incorporated herein by reference in full.

It may be desirable to provide additional cable hanger designs.

### SUMMARY OF THE INVENTION

As a first aspect, embodiments of the invention are directed to a cable hanger. The cable hanger comprises: a generally flat base with an opening; first and second arms extending in a first direction from opposite edges of the base; first and second locking members extending in the first direction from, respectively, ends of the first and second arms, each of the locking members comprising a respective hook; first and second gripping members, each of the first and second gripping members extending from the base or one of the arms and forming a pocket configured to receive and grasp a cable; a support member extending from the base or one of the arms, the support member sized and positioned to engage the first gripping member when the first gripping member deflects to grasp a cable; and a flexible tying section extending between the support member and the first gripping members. The tying section is configured such that, when the cable hanger is not grasping a cable, the tying section has slack therein, but that sufficient deflection of the first gripping while grasping a cable can cause the tying section to become taut, thereby providing additional support to the first gripping member.

As a second aspect, embodiments of the invention are directed to a cable hanger comprising: a generally flat base with at least one opening; first and second arms extending in a first direction from opposite edges of the base; first and second locking members extending in the first direction from, respectively, ends of the first and second arms, each of the locking members comprising a respective hook; first and second gripping members, each of the first and second gripping members extending from the base or one of the arms and forming a pocket configured to receive and grasp a cable; and first and second stabilizing features, each mounted to and extending from a respective one of the first and second locking members. The first and second locking members are forced toward each other to mount the cable hanger in a mounting location via the hooks, such movement causing the first and second gripping members to grasp a cable in the pocket. The first and second stabilizing features are configured so that, when the cable hanger is mounted on a mounting structure and a side load is applied to one of the first and second arms, the first and second stabilizing members engage to inhibit relative movement of the first and second locking members.

As a third aspect, embodiments of the invention are directed to a cable hanger comprising: a generally flat base with at least one opening; first and second arms extending in a first direction from opposite edges of the base; first and second locking members extending in the first direction from, respectively, ends of the first and second arms, each of the locking members comprising a respective hook; first and second gripping members, each of the first and second gripping members extending from the base or one of the arms and forming a pocket configured to receive and grasp a cable; and first and second stabilizing features, each mounted to and extending from a respective one of the first and second locking members. The first and second locking members are forced toward each other to mount the cable hanger in a mounting location via the hooks, such movement causing the first and second gripping members to grasp a cable in the pocket. The first and second stabilizing features are configured so that engagement of the first and second stabilizing members inhibits relative movement of the first and second locking members.

### BRIEF DESCRIPTION OF THE DRAWINGS

FIG. 1 is a perspective view of a prior art cable hanger.

FIG. 2 is a top view of the prior art cable hanger of FIG. 1.

FIG. 3 is a perspective view of a cable hanger according to further embodiments of the invention.

FIG. 4 is a front view of the cable hanger of FIG. 3.

FIG. 5 is a side view of the cable hanger of FIG. 3.

FIG. 6 is a perspective inner section view of the cable hanger of FIG. 3.

FIG. 7 is a schematic side view of a cable hanger according to embodiments of the invention.

FIG. 8 is a schematic side view of a cable hanger according to additional embodiments of the invention.

FIG. 9 is a schematic side view of a cable hanger according to further embodiments of the invention.

FIG. 10 is a schematic side view of a cable hanger according to still further embodiments of the invention.

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the below description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

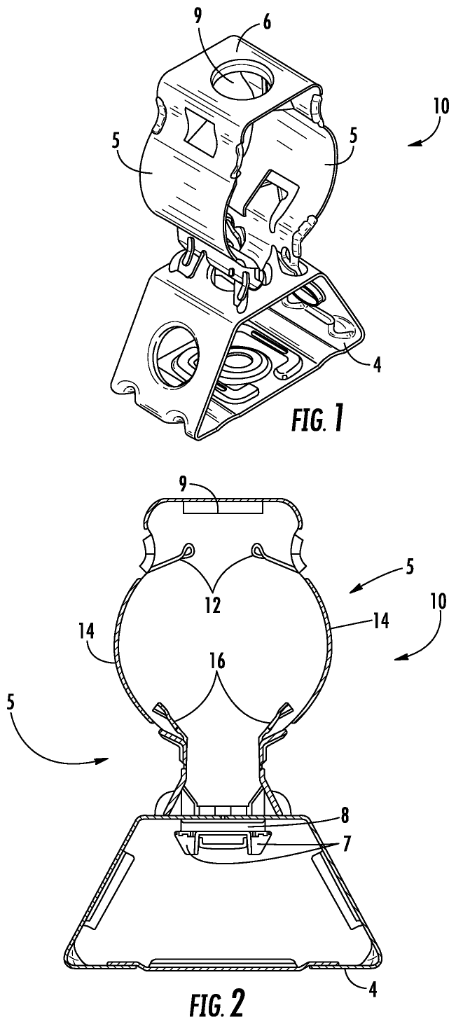

Referring now to the figures, a prior art cable hanger, designated broadly at 10, is shown in FIGS. 1 and 2. The hanger 10 includes curved arms 5 that extend from a flat base 6. Locking projections 7 extend from the free ends of the arms 5. As can be seen in FIGS. 1 and 2, the locking projections 7 are inserted into a reinforced hole 8 in a tower structure 4 to mount the hanger 10 thereon. The base 6 of the hanger 10 includes a reinforced hole 9 that can receive the projections of another hanger 10 to mount a second cable.

As can be best seen in FIG. 2, the arms 5 include arcuate sections 14 that together generally define a circle within which a cable can be grasped. Two cantilevered tabs 12 extend radially inwardly and toward the base 6 at one end of the arcuate sections 14, and two cantilevered tabs 16 extend radially inwardly and toward the base 6 from the opposite ends of the arcuate sections 14. The cantilevered tabs 12, 16 are deployed to deflect radially outwardly when the hanger 10 receives a cable for mounting; this deflection generates a radially inward force from each tab 12, 16 that grips the jacket of the cable.

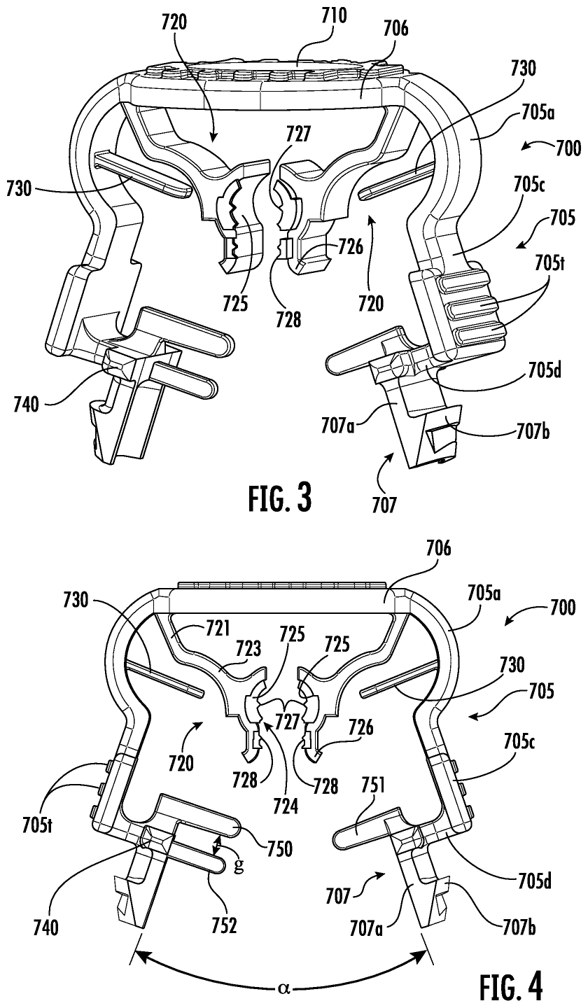

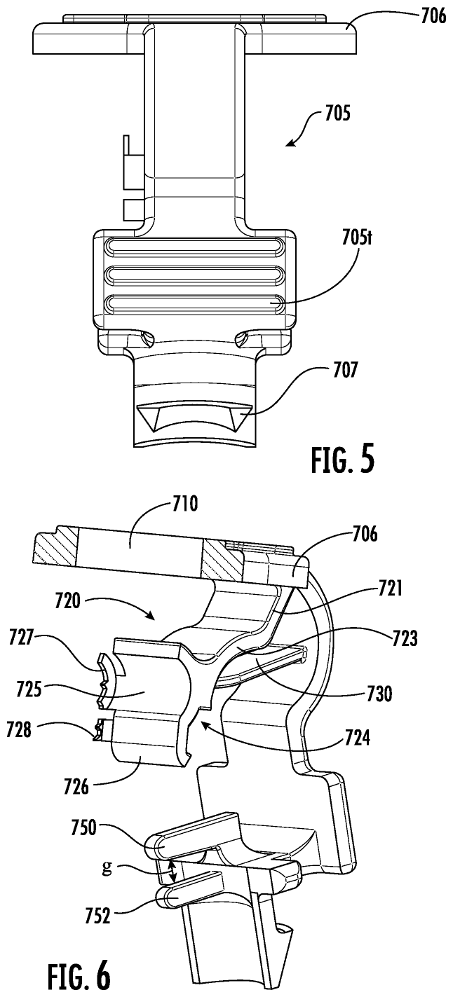

The hanger 10, which is often formed of a metallic material such as steel, is popular for the mounting of larger coaxial cables (which tend to be provided in relatively few different sizes), but may be less popular for smaller cables. A further embodiment of a cable hanger, designated broadly at 700, is shown in FIGS. 3-6. The cable hanger 700 includes a base 706 with arms 705 that originate from the base 705 and extend generally perpendicularly therefrom. Each of the arms 705 includes an arcuate portion 705a, a straight segment 705c, and an inwardly-directed section 705d. The base 706 includes a mounting hole 710 similar to that described above (i.e., it is typically a nominally ¾ inch diameter unobstructed round hole). A locking portion 707 extends from the inward end of each inwardly-directed section 705d in a direction away from the base 706; each of the locking portions 707 includes a base segment 707a and a hook 707b that are arcuate in profile, and that are sized and configured to mount within a hole or sections of a hole such as that of mounting hole 710 described above. It can also be seen that the arms 705 are configured so that, when the cable hanger 700 is in a relaxed position, the locking members 707 define an angle a that is typically between about 10 and 40 degrees. In some embodiments, the straight segments 705c may include ribs or other texture 705t that can provide the operator with an enhanced grip when grasping and deflecting the cable hanger 700.

As can be seen in FIGS. 3 and 4, the cable hanger 700 includes two gripping members 720. Each of the gripping members 720 is mounted to the base 706 and extends therefrom toward the locking portions 707. Each of the gripping members 720 includes a straight section 721, an arcuate section 723, and a gripping portion 724. The gripping portion 724 includes a concave surface 725 and a guide portion 726. Notably, a toothed blade 727 is mounted adjacent the concave surface 725, and a second toothed blade 728 is mounted adjacent the guide portion 726.

The cantilevered mounting of the gripping members 720 enables them to deflect toward the arms 705 to receive a cable, then recover somewhat from such deflection to grasp and hold a cable positioned between the gripping portions 724. The toothed blades 727, 728 can assist with gripping a grasped cable. Also, in particular the toothed blade 728 can help to prevent a grasped cable (particularly a larger cable) from slipping or sliding downwardly (i.e., toward the locking portions 707). The presence of the toothed blades 727, 728 may enable the cable hanger 700 to be employed with a wider variety of cable sizes (which in turn may enable a supplier of cable hangers to manufacture fewer different cable hanger sizes, thereby lowering capital expenditures and manufacturing costs).

The cable hanger 700 includes a straight support member 730 mounted to each arm 705. The support member 730 is mounted near the center of the arcuate portion 705aand extends at an oblique angle therefrom (in the illustrated embodiment, the support member 730 extends generally toward the center of the adjacent concave surface 725. The support members 730 are included to provide additional support and gripping force to the gripping members 720 for larger cables.

In addition, and as shown in FIGS. 3-6, the cable hanger 700 includes stabilizing members 750, 752 extending from one arm 705 and another stabilizing member 751 extending from the other arm 705. As shown in FIG. 4, a gap g is present between the stabilizing members 750, 752. When the arms 705 are drawn together to grasp a cable, the stabilizing member 751 is received within the gap g and is captured therein by the stabilizing members 750, 752. This interaction can prevent the movement of the locking members 707 toward each other under wind loading as described above. The benefits of the stabilizing member 750, 752 are discussed in greater detail in U.S. patent application Ser. No. 17/577,570, filed Jan. 18, 2022, the disclosure of which is hereby incorporated herein by reference in full.

Further, two tabs 740 extend from and in a direction normal to the ends of each of the arms 705 (see FIG. 14). The tabs 740 can overlie a surface to which the cable hanger 700 is mounted and provide a stabilizing structure (i.e., the mounting surface may be captured between the upper surfaces of the hooks 707b and the lower surfaces of the tabs 740.

A second cable hanger 700 can be employed to mount a second cable to the cable hanger 700. The hooks 707 of the arms 705 of the second cable hanger 700 are inserted into the hole 710 in the base 706 of the first cable hanger 700. Additional cable hangers 700 can then be “stacked” onto the second cable hanger 700.

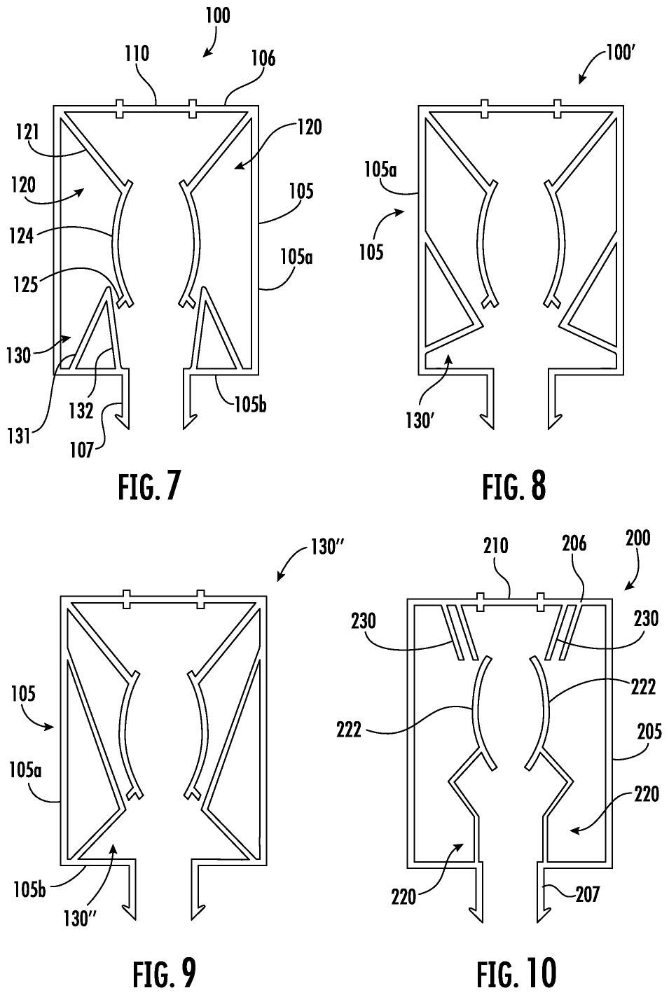

Another embodiment of a cable hanger, designated broadly at 100, is shown in FIG. 7. The cable hanger 100 includes a base 106 with arms 105 that originate from the base 106. A vertical section 105a of the arms 105 extends generally perpendicularly from the base 105, and a horizontal section 105b of each of the arms 105 extends inwardly toward the other horizontal section 105b. The base 106 includes a mounting hole 110 similar to that described above (i.e., it is typically a nominally ¾ inch diameter unobstructed round hole). A locking portion 107 extends from the horizontal section 105b of each arm 105 in a direction away from the base 106; each of the locking portions 107 is sized and configured to mount within a hole or portions of a hole such as that of mounting hole 110 described above. Although the locking portions 107 are shown as being parallel to each other, in some embodiments the locking portions 107 may be splayed, as described in U.S. patent application Ser. No. 17/577,570, supra.

The cable hanger 100 includes two gripping members 120. Each of the gripping members 120 is mounted to the base 106 and extends therefrom toward the locking portions 107. Each of the gripping members 120 includes a straight section 121 and a concave gripping portion 124. On the back side of the gripping portion, an optional projection 125 may be present.

Like the cable hanger 700, the cable hanger 110 includes support members 130; however, rather than being formed as a cantilevered beam like the support members 730, the support members 130 are formed as a fixed-fixed beam (triangular in profile in this embodiment), with a hollow interior surrounded by legs 131, 132 (see FIG. 7). The support members 130 may be mounted on the horizontal section 105b of the arms 105 (at 130 in FIG. 7), on the vertical section 105a of the arms (at 130′ in cable hanger 100′ in FIG. 8), or spanning the horizontal and vertical section 105b, 105a of the arms 105 (at 130″ in cable hanger 130″ in FIG. 9).

In use, a cable is positioned between the gripping members 120, where it is grasped by the gripping portions 124. As the gripping members 120 deflect, they may contact the support members 130, 130′, 130″, which resist the gripping members 120 and therefore increase the gripping force applied to the cable.

Fixed-fixed beam support members such as the support members 130, 130′, 130″ discussed above may provide more resistive support to the arms 105 as they deflect to receive and grasp a large cable. In addition, hollow fixed-fixed beam support members of polymeric cable hangers may be easily molded with a traditional injection mold without the need for “side-actions” mechanisms that can complicate the design and operation of the mold. Those skilled in the art will appreciate that, although triangular-profile support members are shown herein, other profile shapes are also possible; for example, the fixed-fixed beam may be rectangular, pentagonal, arcuate, ovoid, or the like.

Referring now to FIG. 10, another cable hanger, designated broadly at 200, is shown therein. The cable hanger 200 includes a base 206 with arms 205 that originate from the base 206 and extend generally perpendicularly therefrom, then inwardly toward each other. The base 206 includes a mounting hole 210 similar to that described above (i.e., it is typically a nominally ¾ inch diameter unobstructed round hole). A locking portion 207 extends from the inward end of each arm 205 in a direction away from the base 206; like the locking portions 107, each of the locking portions 207 is sized and configured to mount within a hole or sections of a hole such as that of mounting hole 210 described above.

The cable hanger 200 includes two gripping members 220, but unlike the gripping members 120, each of the gripping members 220 is mounted to a respective inward-extending portion of the arms 205 and extends therefrom toward the base 206. Each of the gripping members 220 includes a straight section 221 and a gripping portion 222.

In addition, the cable hanger 200 includes support members 230 that are mounted to the base 205 and extend toward the locking projections 207. The support members 230 are positioned to engage the gripping members 220 when they deflect sufficiently while grasping a large cable. The support members 230 act to provide additional resistive force in the manner of the support members 720, 130 discussed above.

Those of skill in this art will appreciate that other configurations may also be suitable. For example, the support members 230 of the cable hanger 200 may be replaced with triangular support members like the support members 130, which may be mounted on the base 206, the arms 205, or both. Support members of different shapes may be employed, as may arms of different configurations. Other variations may also be employed.

Those skilled in this art will appreciate that the cable hangers 100, 200 discussed above are typically formed of a polymeric material, such as acetal or nylon resin, and may be formed as a unitary member (often via injection molding). The cable hangers 100, 200 may also be configured to grasp different sizes of cables: for example, one size of hanger may be employed to mount cables having an outer jacket with a 4-7 mm diameter (DOJ), another size of hanger may mount 7-10 mm DOJ cables, and a third size of hanger may mount 10-14 mm DOJ cables. Additional configurations for polymeric cable hangers are shown and described in U.S. Pat. No. 10,253,906 and U.S. patent application Ser. No. 17/577,570, supra.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A cable hanger, comprising:
a generally flat base with a mounting opening;
first and second arms extending in a first direction from opposite edges of the base;
first and second locking members extending in the first direction from, respectively, ends of the first and second arms, each of the locking members comprising a respective hook;
first and second gripping members, each of the first and second gripping members extending from a respective arm adjacent one of the first or second locking members, the arms and forming a pocket configured to receive and grasp a cable;
a support member extending from the base or one of the arms, the support member sized and positioned to engage the first gripping member when the first gripping member deflects to grasp a cable.

2. The cable hanger defined in claim 1, wherein the support member is mounted on and extends from the base.

3. The cable hanger defined in claim 2, wherein the support member is a first support member, and further comprising a second support member that extends from the base.

4. The cable hanger defined in claim 1, wherein the opening in the base is configured to receive the hooks of an identical second cable hanger.

5. The cable hanger defined in claim 1, formed of a polymeric material.

6. The cable hanger defined in claim 1, wherein the mounting opening has a nominal diameter of ¾ inch.

7. A cable hanger, comprising:
a generally flat base with at least one opening;
first and second arms extending in a first direction from opposite edges of the base;
first and second locking members extending in the first direction from, respectively, ends of the first and second arms, each of the locking members comprising a respective hook;
first and second gripping members, each of the first and second gripping members extending from the base or one of the arms and forming a pocket configured to receive and grasp a cable;
a fixed-fixed beam support member extending from the base and/or the first arm, the support member sized and positioned to engage the first gripping member when the first gripping member deflects to grasp a cable;
wherein the first and second locking members are forced toward each other to mount the cable hanger in a mounting location via the hooks, such movement causing the first and second gripping members to grasp a cable in the pocket.

8. The cable hanger defined in claim 7, wherein a first end of the support member is mounted on the first arm, and a second end of the support member is mounted on the first arm.

9. The cable hanger defined in claim 8, wherein the first arm has a vertical section that extends from the base and a horizontal section that extends from the vertical section, and wherein the first and second ends of the support member are mounted on the vertical section.

10. The cable hanger defined in claim 8, wherein the first arm has a vertical section that extends from the base and a horizontal section that extends from the vertical section, and wherein the first and second ends of the support member are mounted on the horizontal section.

11. The cable hanger defined in claim 8, wherein the first arm has a vertical section that extends from the base and a horizontal section that extends from the vertical section, and wherein the first end of the support member is mounted on the vertical section and the second end of the support member is mounted on the horizontal section.

12. The cable hanger defined in claim 7, wherein a first end of the support member is mounted on the first arm, and a second end is mounted on the base.

13. The cable hanger defined in claim 7, wherein the support member has a triangular profile.

14. The cable hanger defined in claim 7, wherein the opening in the base is configured to receive the hooks of an identical second cable hanger.

15. The cable hanger defined in claim 7, formed of a polymeric material.

16. The cable hanger defined in claim 1, wherein the mounting opening has a nominal diameter of ¾ inch.
